(19) United States
(12) Patent Application Publication
(10) Pub. No.: US 2010/0145815 A1
(43) Pub. Date: Jun. 10, 2010

(54) SYSTEMS AND METHODS FOR INITIATING ANONYMOUS CONTACT WITH BUYERS AND SELLERS

(76) Inventor: Weiwen Weng, Sunnyvale, CA (US)

Correspondence Address: O'Connor & Company, P.O. Box 7389, Broomfield, CO, 80021-0024, US

(21) Appl. No.: 12/652,741

(22) Filed: Jan. 5, 2010

Related U.S. Application Data
(63) Continuation-in-part of application No. 12/326,893, filed on Dec. 3, 2008, now Pat. No. 7,668,757.

(51) Int. Cl. G06Q 30/00

(52) U.S. Cl. 705/26

(57) ABSTRACT

According to the invention disclosed herein, methods and systems are disclosed that proactively and anonymously reach out to potential service providers to screen and select one or more service providers for the consumer. Such methods would be time-consuming to conduct manually but are automated efficiently and flexibly as described herein. These methods and systems are not limited to service providers who have pre-registered at any particular web site or directory.

### PRIORITY DATA

This patent application is a continuation-in-part of U.S. patent application Ser. No. 12/326,893, filed Dec. 3, 2008, which claimed the priority benefit of U.S. Provisional Patent App. No. 61.059,808, filed Jun. 9, 2008. The disclosures of each of these patent applications are hereby incorporated by reference herein.

### FIELD OF THE INVENTION

The present invention relates generally to the field of consumer procurement of products and services over the Internet. The invention relates more specifically to methods and systems for locating buyer and sellers of products or services.

### BACKGROUND OF THE INVENTION

Current online advertisement is dominated by provider-based ads. However, provider-based ads (ads paid by the service provider) have many drawbacks. First, these ads can be distracting for non-buying users. Second, the conversion rate is usually low; many clicks occur without actual materialization of any transaction. Third, it is inefficient for consumers to search a large number of ads, hoping to find appropriate service providers and vendors. It can be time-consuming for consumers, inefficient for business marketing and further it can miss locating several viable service providers.

One possible solution is to allow consumer to list their requests and hope that providers will respond. Such known services include Craigslist.org and the like. However, these services can be problematic. In some cases, a user does not know how many (if any) suitable service providers subscribe to, or have access to, a particular service. In addition, a user may not know whether his request was, or will be, viewed by any provider. In other cases, users may need to provide a phone number and other details in order to get any quotations. Giving contact information is known to lead to many potential problems for users, such as unwanted e-mails, phone calls, and mail.

In many current web-based services, a user must provide a valid phone number to receive detailed information from the service provider. However, this typically will lead to a barrage of unwanted phone calls and e-mails from multiple providers vying for the user's business. These providers often poorly understand the user's desires and requirements, thus resulting in an unpleasant and inefficient user experience.

For example, ServiceMagic (www.servicemagic.com) is a service matching users to prescreened, customer-rated service professionals for home services, such as landscaping, remodeling, etc. Upon using the ServiceMagic services, a user “will be prompted to disclose certain information . . . this information will be sent to service professionals who will need this information to respond to you or to other persons or entities . . . ” (www.servicemagic.com, May 2008). By providing this information, or by submitting a service request, a user expressly consents to being contacted by ServiceMagic and by service professionals. ServiceMagic may collect information that can identify a user, such as name and e-mail address, and further may combine the personal information received from different sources.

As another example, intended to point out shortcomings associated with the art, AgentEvaluator (www.agentevaluator.com) is an internet site that allows home buyers and sellers to compare real-estate agent professionals and brokers to help buy or sell a home. While advertised as “anonymous,” the policies described therein state that personally identifiable information such as name, e-mail address, or phone number is necessary “to provide the personalized or enhanced service that [a user] has requested.” A user is asked to enter his or her address and phone number even though the site claims that those contact details are not sent to service providers. Clearly, such methods and systems are not substantially anonymous and are not desirable from the point of view of a consumer.

As an example in the home-mortgage market, according to a March 2008 survey conducted by Harris Interactive (cited at http://zillow.mediaroom.com), it can be more important for borrowers to keep their contact information private than to find the best rates. Lenders can be too eager to sell the borrowers on a deal after they know how to find borrowers. In addition, borrowers are concerned about having their personal information sold or shared. Therefore, the need to protect consumers' identities and tip the balance of power into their favor is paramount.

Some known methods employ “reverse auctions.” A reverse auction (also called procurement auction, e-auction, sourcing event, or e-sourcing) is a type of auction in which the role of the buyer and seller are reversed, with the primary objective usually to drive purchase prices downward. In an ordinary auction (also known as a forward auction), buyers compete to obtain a good or service. In a reverse auction, sellers compete to obtain business.

Web-based reverse auctions have become popular for purchasing everything from accounting services to securing raw materials. With these reverse auctions known in the art, buyers typically create a project description and post it online. Invitations are then sent out to registered vendors who can place a bid if desired. Limitations of such services include that only registered vendors will be notified or have access to such requests. Because the pre-registered vendors with any specific service or web site will typically represent a small percentage compared to open business-directory-listed vendors, suitable vendors may never become aware of such requests. Business opportunities can therefore be missed in these reverse auctions.

There remains a need in the marketplace for improved methods and systems that better empower consumers to efficiently find suitable service providers. Specifically, what are needed are methods and systems that proactively reach out to potential service providers to screen and select one or more service providers for the consumer, such methods and systems not being limited by pre-registration of service providers.

In view of serious shortcomings (to the consumer) associated with known methods, it would further be particularly advantageous for methods and systems to keep the identity of consumers private throughout the provider screening process as much as possible, until a prospective vendor satisfies screening criteria defined by the consumer and/or further negotiation requires disclosure of private contact information. It would be beneficial for any disclosure to be completely voluntary between the consumer and the vendor and not be disclosed to any third party.

### SUMMARY OF THE INVENTION

The disclosed methods herein can generally match one or more buyers with one or more sellers of any product, service, or general article of trade or commerce.

In some variations, the present invention provides a method of finding at least one suitable provider of a service requested by a user, the method comprising:

(i) receiving, at a network-connected computer server, a service request submitted by a user;

(ii) generating, in the network-connected computer server, an initial list of a plurality of service providers, wherein at least one of the plurality of service providers is open-listed and each open listing is associated with a method of contact selected from the group consisting of telephone number, fax number, e-mail address, web address, instant message, and text message;

(iii) producing, in the network-connected computer server, a message, comprising the service request, from data supplied by the user;

(iv) providing an automated system capable of contacting the service providers, wherein the system is integrated with the network-connected computer server;

(v) contacting at least two of the plurality of service providers and communicating the message provided according to step (iii); and

(vi) allowing for at least one suitable service provider to contact the user.

In some embodiments, the message in step (iii) is a voice message, the system in step (iv) is an automated telephony system, and the communicating in step (v) comprises automated telephone calls. In some embodiments, communication in step (i) and/or step (vi) includes one or more means selected from the group consisting of Internet, telephone, Internet phone, facsimile, satellite phone, radio, e-mail, instant messaging, and cellular text messaging. The contacting in step (v) can be achieved by a conference call wherein user contact information is not communicated to the providers.

Some embodiments further include step (vii), the user selecting one or more service providers to actually provide the service. However, the invention can be carried out without a user ultimately selecting any particular service provider.

In some variations, the invention provides a method of finding at least one suitable provider of a service requested by a user, the method comprising:

(i) receiving, at a network-connected computer server, a service request submitted by a user;

(ii) generating, in the network-connected computer server, an initial list of a plurality of service providers, wherein at least one of the plurality of service providers is open-listed and each open listing is associated with a method of contact selected from the group consisting of telephone number, fax number, e-mail address, web address, instant message, and text message;

(iii) contacting separately at least two of the plurality of service providers and communicating the service request; and

(iv) allowing for at least one suitable service provider to contact the user.

Some embodiments of this variation include an assisted conference call with a customer representative, the user, and the service provider. The customer representative can assist the service provider prior to connection with the user. Alternatively, or additionally, the customer representative can assist the user prior to connection with the service provider or while keeping the service provider on hold before the user is connected to the conference call.

Some embodiments further include real-time streaming of a phone conversation that includes the service provider, to the user prior to the conference call. For example, the phone conversation can be recorded to a file that is continuously written during the phone conversation; the file can be converted into an audio signal for transmission over a network to the user. Or, a server can directly stream an audio device connected to a computer by hardware.

Some methods of the invention utilize a virtual audio device technique. In some embodiments, a plurality of virtual audio devices on a single physical machine can be used to conduct a plurality of phone call simultaneously.

In various embodiments, a service provider receives live instructions or a voice message with information for retrieving the service request, and optionally following up, via the Internet. The retrieving can be accomplished by the provider typing in a business phone number or identification number associated with the provider.

In certain variations of the invention, a method of finding at least one suitable provider of a service requested by a user comprises the following method steps:

(i) receiving, at a network-connected computer server, a service request submitted by a user;

(ii) generating, in the network-connected computer server, an initial list of a plurality of service providers, wherein at least one of the plurality of service providers is open-listed and each open listing is associated with a method of contact selected from the group consisting of telephone number, fax number, e-mail address, web address, instant message, and text message;

(iii) contacting separately at least two of the plurality of service providers and communicating the service request;

(iv) allowing for at least one suitable service provider to contact the user; and

(v) generating an Internet-based discussion thread suitable for participation by multiple persons, wherein a provider can place a bid even if the provider is not contained on the initial list of a plurality of service providers.

In some embodiments, an e-mail containing the service request is transmitted to the service provider, wherein the e-mail includes an identifying Internet link for connecting to data comprising the service request.

Variations of the invention are premised on the realization that e-mail anonymization can be employed to protect the identity of a buyer in the marketplace. In some variations, a method of anonymously matching one or more buyers with one or more sellers for a product or service comprises the steps of:

(i) receiving, at a network-connected computer server, a request submitted by a buyer having a buyer e-mail address that is recorded on the computer server;

(ii) converting the buyer e-mail address to an anonymized e-mail address that is mapped to the buyer e-mail address, wherein the converting is computationally carried out within the computer server;

(iii) generating, in the network-connected computer server, a list of a plurality of sellers, wherein at least one of the sellers is open-listed;

(iv) allowing the buyer to select, for inquiry, at least one selected seller from the list of a plurality of sellers;

(v) sending, from the computer server, an inquiry e-mail to the at least one selected seller using the anonymized e-mail address as sender address, wherein the inquiry e-mail includes instructions for optionally retrieving the request via the Internet.

In some embodiments, an Internet-based discussion thread suitable for participation by multiple persons is provided, wherein a seller can place a bid even if the seller is not contained on the list of a plurality of sellers from step (iii). The selected seller can optionally post, on the discussion thread, an anonymous offer to the buyer.

Some embodiments further comprise receiving a seller reply e-mail from the selected seller via the anonymized e-mail address, and then relaying the seller reply e-mail to the buyer e-mail address. Some embodiments further comprise sending a notification to the buyer to retrieve the seller reply e-mail via the Internet, preferably at a web site associated with the marketplace linked to, and under at least partial control of, the network-connected computer server.

Certain embodiments additionally comprise implementing an automatic task scheduler for conducting searching of said sellers to match said buyer's service request and sending inquiries to some or all of said sellers from each task.

### BRIEF DESCRIPTION OF THE DRAWINGS

FIG. 1 shows an exemplary system embodiment of the present invention.

FIG. 2 shows an exemplary method embodiment of the present invention.

FIG. 3 depicts a schematic for the QuestBid™ system, in some variations of the present invention.

### DETAILED DESCRIPTION OF EMBODIMENTS OF THE INVENTION

Some embodiments of the present invention can be described as follows.

A “user” as used herein means a person or persons, such as a consumer or agent for the consumer. “User” is intended to also broadly describe any person that might use a method or system of the invention, such as a person conducting research.

A “vendor,” “provider,” “service provider,” or “business provider,” or the like, are terms that are used interchangeably herein to mean a person, company, firm, agent, or other entity that can provide, or cause to be provided, one or more services or products desired by a user pursuant to a service request.

A “buyer” means a person, company, firm, agent, or other entity that seeks to purchase or otherwise acquire one or more services or products. A “seller” means a person, company, firm, agent, or other entity that is marketing or otherwise offering one or more services or products. As used herein, “seller” and “service provider” can be used interchangeably.

A “service request” as used herein means a request for at least one service, product, or some other form of commerce that can be sold in the marketplace.

For present purposes, “proprietary registration” means pre-registration by a service provider in a directory, or the like, which requires some action or intent by the service provider including, for example, paying a fee and/or contacting the directory with details about the serviced that can be provided. Examples of proprietary registration include, but are not limited to, listing with private business-listing companies and web sites such as www.servicemagic.com and www.realtor.com.

For present purposes, “open listing” (or “open-listed”) means a record associated with a service provider, or on behalf of a service provider, in a directory, listing, book, or the like, wherein information pertaining to the service provider is substantially publicly available. Open-listed information is generally available without paying a fee directly for the information, even if collection of the information is not necessarily a routine matter.

Some embodiments of the present invention are premised on the realization, at least in part, that virtually all business open listings are associated with at least one method of contacting the business, in order for the listings to be effective for searching, advertising, and/or marketing purposes. Such methods of contacting include, but are not limited to, telephone number, e-mail address, web address, and fax number.

Examples of “open listing” include, for example, business listings in the Yellow Pages (which list e.g. telephone numbers), commerce and regulatory information, web sites such as local.yahoo.com and similar web sites, search-engine results (which list e.g. internet URL addresses), search-engine ad feeds, and so on. Other examples of open listing include vertical-domain third-party aggregators (such as, for example, www.vast.com) and classified listings. An example of a classified listing is one at craigslist.org, wherein the listing may utilize anonymous e-mail redirection as a method of contact. Anonymous e-mail redirection means that contact can be initiated with a provider without knowing the provider's actual e-mail address or any other unique contact information.

Open listing is also intended herein to include the capture of data streams associated with searches (e.g., searches using Google), by a skilled artisan in the Internet and computer-programming arts, and the extraction of information from the data, such as paid-advertisement business-provider information.

A “computer server” (or “server computer,” or “server”) for the purposes of the present invention includes a processor and memory. In accordance with the present invention, a server is capable of communicating on a computer network, such as the Internet. The server includes a suitable link to the network, which is itself linked to a plurality of user computers or other network devices. The server itself can be a network of individual computers or processing units.

The term “Internet” as used herein is intended to embrace generically all types of public and/or private communication networks using wireless and/or wired transmission media, and combinations of the above.

As provided and described herein, a “virtual agent” is a means to translate a consumer's request into an inquiry to one or more service providers (or sellers) in a substantially automated fashion on behalf of the consumer. The virtual agent can accomplish such inquiry by telephone, e-mail, fax, instant message, text message, or by some other known means of electronic communication or telecommunication.

A user can submit a service request and optionally submit certain screening criteria or conditions, as will be more fully described below. The submission of a service request is preferably performed at a web site, with data communicated via the Internet. A user can register with a computer server, either initially or after the submission of an initial request.

In some embodiments, the user can first register and/or submit a service request by telephone, facsimile (fax), Internet phone, satellite phone, radio, or any other known means of telecommunications. The user can preferably choose his or her desired means of communication.

Screening criteria or conditions imposed by a user can relate to the specific service request or to characteristics of service providers. For example, conditions could define, at least in part, the requirements of what is sought—item(s) to be bought or sold (such as a home); special features of the service; when the service needs to be conducted; and so on. These conditions could take the form of requests that are commonly known as requests for quote, requests for information, requests for proposal, and the like.

Criteria that relate more specifically to service providers could be, for example: years in the business; professional licensure; typical time to conduct or complete the service; experience with the type of service being requested; the ability to provide one or more references; language; location; rate of charges; and payment options.

As an example, a user may wish to find a real-estate agent that can speak Chinese and has prior transactions in the neighborhood, and will work at 3% or lower commission. Or a user may wish to hire a lawyer with patent-litigation experience in a certain technology, who is licensed to practice in California and will work on contingency. Other screening criteria and conditions will be contemplated by a person of ordinary skill in the art.

In preferred embodiments, the computer server receives a service request and provides an initial result to the user. This initial result can comprise a listing of one or a plurality of possible service providers that might be satisfactory to the user for the certain service request(s). In some embodiments, one or more service providers in the initial result may not match all of the screening criteria or conditions but will be directed to the appropriate category of service providers (e.g., real estate, law, etc.).

In preferred embodiments, the computer server generates the initial result by aggregating various open-listing data sources. Proprietary registration of a provider is not necessary in order to deliver a consumer's service request.

In some embodiments, service providers can register with the system of the invention, which registration may be regarded as proprietary registration with the server provided herein. In these embodiments, methods of the invention, when later conducted, can comprise a computer server generating an initial result by aggregating various data sources that include both proprietary registration and open listing, wherein the proprietary registration is associated at least with a server provided by the present invention.

In certain embodiments, methods of the invention, when conducted, can comprise a computer server generating an initial result by aggregating data sources that include primarily those associated with proprietary registration, wherein the proprietary registration is associated at least with a server provided by the present invention.

The user can select the service providers, if any, for which inquiries should be made. The computer server then generates a voice message from text entered by the user or from a direct voice recording from the user. This message preferably includes the basic service request and at least some of the screening criteria.

In some embodiments, the computer server generates an e-mail or other text message from text entered by the user or from a direct voice recording from the user. Again, this message preferably includes the basic service request and at least some of the screening criteria.

In some embodiments, the initial result is used directly by the computer server to contact one or more service providers, without any intermediate selection by the user. This mode can be beneficial when a user desires a highly automated, proactive, and comprehensive approach, notwithstanding that it might lead to relatively large numbers of calls to service providers.

The computer server utilizes (in some embodiments) an automated telephony system to call the selected service providers and play the service-request message. If a provider satisfies certain criteria, which relate to the screening criteria, the virtual agent (via the computer server) can then allow for the provider to be connected directly to the user by telephone, e-mail, or some other means of communication as specified by the user. In some embodiments, the connection with the user can be instantaneous, if the user so desires rapid communication.

Automated telephony can involve the use of digital technology in the provision of telephone services and systems. For example, IP Telephony is a modern form of telephony which uses the TCP/IP protocol popularized by the Internet to transmit digitized voice data. However, the present invention can implement automated telephony in standard analog systems as well. Some embodiments utilize analog-to-digital converters in making the various links involving computer servers, telephones, and human voices.

It is preferred that a user need not provide a phone number or other details in order to talk to a provider. The communication link is accomplished by the virtual agent on behalf of the user, in an anonymous manner. In some embodiments, all disclosure is completely voluntary between the consumer and the vendor and such disclosure is not provided to any third party, including third parties associated with the methods and systems of the present invention.

If a service provider has not registered with the computer server, the service provider can be redirected to a registration page wherein the provider will be asked to create an account. In some embodiments, the provider's information can be pre-populated by public data available, such as phone number, company address, and the like.

The computer server can be programmed with instructions to call (or otherwise inquire) an unregistered service provider up to a prescribed number of times. Unregistered providers can be asked to sign up with the server/service of the invention each time such provider is contacted. This preset limit can be, for example, in the range of 1-10 calls, preferably 2-5 calls, and more preferably 3 calls, in some embodiments. The preset limit can vary with business category and other factors, as will be appreciated. If a provider declines to register within a preset limit of inquiries, no further calls are preferably made to that service provider. Of course, exceptions can be possible.

Registration of a service provider with the server/service of the invention can take a variety of forms, and may be proprietary registration. In some variations, a plurality of service plans can be made available to service providers. Different plans can have different costs associated with them; there can be both no-cost and fee-based service plans. Upon registration, a service provider can specify preferred means of notification, which may be selected from telephone calls, e-mails, short message service (SMS) messages, really simple syndication (RSS) feeds, instant messaging, and so on. A default can be set in the absence of specific selection; e-mail is a preferable default due to its low per-transmission cost.

In some embodiments of the invention, when a service request is submitted by a user, the computer server creates a discussion thread on a web site associated with the server. A “discussion thread,” or “threaded discussion,” is an electronic discussion in which software aids users by visually grouping messages. Messages are usually grouped visually in a hierarchy by topic. A set of messages grouped in this way is called a “thread.”

This discussion thread can be made available to multiple persons, including all users and providers, rather than only the user and providers linked to the service request. This can have practical and economic advantages for users (and providers) as will be recognized. It is, of course, even possible to make these discussion threads (or parts thereof) available publicly on the Internet.

In these discussion threads, others can enter recommendations for providers they know or with which they have experience. Additionally, registered providers can review these discussion threads and can bid for certain projects if desired (i.e., for projects in which they were not previously inquired). In some embodiments, the user and provider can jointly choose to utilize the server-generated discussion thread as a primary means of communication, for convenience or another reason. The computer server can send reminders to users and providers to request feedback in the discussion threads.

When a prospective service provider is connected to a user, both the user and the provider are preferably free to negotiate the terms of a transaction, if any. In various embodiments of the invention, a user and provider can choose to follow up and conduct discussions privately by web-based tools, e-mail, phone, live meetings, or any other form of communication.

A specific service request may not lead to a satisfactory provider for the user; that is, the user is not forced into choosing a provider. Also, a user can ultimately make a selection not only according to the lowest price but also according to one or more of the following factors: scope of the actual service to be provided, timing, demonstrated quality, perceived quality, reputation, flexibility, capacity, overall capabilities, a desire by the user to establish a relationship for future business, or for any other reason.

A beneficial aspect of embodiments of the present invention is that it tends to lead to better deals for consumers. Preferred methods and systems can create transparency wherein multiple offers from different providers are aggregated and presented to the consumer. As an additional benefit, this transparency also can let providers know about competing offers, which can lead to more-competitive deals for consumers and can give business providers useful feedback to adjust their methods of doing business.

It will also be appreciated that methods and systems of the invention can reduce advertising and marketing costs for service providers. Sales leads can be brought directly and proactively to providers, who can then focus their efforts on real leads rather than relying on marketing strategies with relatively low probabilities of success.

Embodiments and variations of the present invention can be used by any consumer or other user (such as an agent for a consumer) interested in services and products such as, but by no means limited to, accounting, tax preparation, consulting, legal services, medical services, engineering services, intellectual-property services, patent protection, financial services, real-estate transactions, residential construction, landscaping, and other significant residential projects. Services contemplated herein also include a variety of non-trivial transactions for purchase of products such as vehicles, computer systems, office equipment, home furnishings, vacation packages, and insurance policies, to name only a few for illustrative purposes.

The present invention is particularly suitable for any consumer services and products that cannot be fully described by, e.g., product specification, model number, and a fixed price.

Some variations of the invention employ human intervention at various points in the process. It will be appreciated by a skilled artisan that while certain steps could be automated, that is not necessary or even preferable in some embodiments. Whether a specific step is automated or conducted manually will generally be dictated by economics, business strategy, and/or practical concerns. Notably, it is recognized that notwithstanding the advantages provided by automated systems, human intervention (i.e. the presence of another person on the call) can be helpful to educate the parties involved, answer specific questions, or instill a level of comfort to users who may prefer human contact.

In some variations, the invention provides a method of finding at least one suitable provider of a service requested by a user, the method comprising:

(i) receiving, at a network-connected computer server, a service request submitted by a user;

(ii) generating, in the network-connected computer server, an initial list of a plurality of service providers, wherein at least one of the plurality of service providers is open-listed and each open listing is associated with a method of contact selected from the group consisting of telephone number, fax number, e-mail address, web address, instant message, and text message;

(iii) contacting (either manually or via an automated system) at least two of the plurality of service providers separately and communicating the service request; and

(iv) allowing for at least one suitable service provider to contact the user.

The consumer can select which providers to contact; or, the system can automatically select and make inquiries without consumer interaction. The system can select and make inquiries for the consumer using prescribed criteria which can be based, at least in part, on known user preferences.

Some embodiments of this variation include an assisted conference call with a customer representative, the user, and the service provider. The customer representative can assist the service provider prior to connection with the user. Alternatively, or additionally, the customer representative can assist the user prior to connection with the service provider.

In some embodiments utilizing an assisted conference call, a customer representative will be available before the parties are connected. This will help the parties understand the context of the call.

For example, in some embodiments, a consumer submits a request and receives an initial list of potential providers. An automated call is placed to a selected provider who is given the opportunity to listen to a recorded message. Then, the provider is connected to a customer advocate (by conference call) who will advise the provider how to proceed when the consumer is connected to the conference call. Next, the consumer is connected via conference call (automatically or manually) and the customer advocate can introduce both sides and recap the consumer's request to set the context. Once both sides are able to interact on the request, the advocate can leave the teleconference. The provider and consumer talk to each other, possibly resulting in a service appointment or transaction.

In some embodiments, calls to providers—whether answered by a live person or by an answering machine or system—include recorded information on how to follow up on-line. Such information can include instructions for the provider to type in their business phone number on the web site to retrieve the request, where the web site then connects to the forum to follow up. Such information in the phone message can include instructions for the provider to type in a request identification number or business identification number to retrieve the request.

Some variations of the invention implement real-time streaming of the initial phone conversation involving a selected service provider, streamed to the customer, before a conference call is initiated. This feature addresses the practical issue that when a consumer is connected to the conference call, the consumer will not typically know the context of the call. Preferably, the consumer will interact with the system via Internet browser which has a suitable audio plug-in or add-on installed, such as (for example) Adobe Flash or Microsoft Mediaplayer. The consumer's computer should have a speaker, earphone jet, or other device to listen to the streaming audio.

For example, in some embodiments, a consumer submits a request and receives an initial list of potential providers. The consumer then selects a provider for inquiry. The system (also referred to herein as the “marketplace,” e.g. QuestBid™) places a phone call to the provider in real time. The provider optionally answers the call and listens to the inquiry or request message. In some embodiments, a customer advocate then enters the call, as described above.

The system records the phone call to a file, continuously writing to the file as the phone call is in session. A real-time audio stream server accesses the recorded file, and streams the audio signal continuously as the file is being written in real time. The consumer's Internet browser's audio plug-in receives the audio stream via the network by certain protocol (Hypertext Transfer Protocol, http, for example). Optionally, multiple phone calls can be carried out on the same computer and be streamed by the same server.

The streaming server can directly stream the audio device, which is bound by hardware on the computer. Alternatively, one can employ a technique of Virtual Audio Cable to have unlimited virtual audio devices on the same physical machine to conduct virtually unlimited number of phone calls simultaneously.

The consumer is able to hear the phone call to the provider in real time. If the provider chooses to speak to the consumer, the consumer will be connected by phone. Or, the customer advocate is connected first. In these embodiments, the consumer should be more prepared when his or her phone rings, and the process may be more enjoyable for the consumer.

Still other variations of the invention utilize an e-mail approach, as follows. First, an initial list of a plurality of service providers is generated from an Internet portal such as Craigslist, Google, or Yahoo, in conjunction with a specific search. Advertisements (or postings) resulting from this search can be presented along with the provider contact info, e.g. e-mail or a phone number from the ad. Then, the user selects which ads are interesting, i.e. which providers for which to make inquiries. Alternatively, the system can select and make inquiries for the user using prescribed criteria which can be based, at least in part, on known user preferences.

An e-mail containing a user request is sent to the provider. A link to a forum posting of the user request is included in the e-mail to invite the provider to follow up on the request online. The provider then can post a reply or submit an offer/bid to the consumer request in the forum. The provider may directly contact (online, e-mail, or private message) the consumer by various links in the forum.

This variation can be advantageous because a consumer need not send individual e-mail inquiries to providers/sellers, and the system can aggregate the seller responses in forum replies, leading to transparency and therefore competition which benefits the consumer. Also, the consumer has more control regarding privacy. The consumer can choose to do forum interaction only, so that a user name but not an e-mail address is visible. This variation can also help providers/sellers generate more leads. Significantly, this variation can be carried out by any individual buyers and sellers, not solely for businesses offering products or services.

Other variations of the present invention utilize e-mail anonymization as will now be described. These variations can be applied not just for users and providers for local service, but rather for buyers and sellers in general.

In some embodiments, an anonymous user (without any registration) posts a request with a confirmed e-mail address, which is only known to the marketplace (e.g., QuestBid). The request can be submitted using a browser at an Internet site, or by transmission of electronic mail, a text message, an instant message, a social-networking linked message, or any other means of posting a request. E-mail anonymization can be employed to protect the identity of a buyer in the marketplace. In some variations, a method of anonymously matching one or more buyers with one or more sellers for a product or service comprises the steps of:

(i) receiving, at a network-connected computer server, a request submitted by a buyer having a buyer e-mail address that is recorded on the computer server;

(ii) converting the buyer e-mail address to an anonymized e-mail address that is mapped to the buyer e-mail address, wherein the converting is computationally carried out within the computer server;

(iii) generating, in the network-connected computer server, a list of a plurality of sellers, wherein at least one of the sellers is open-listed;

(iv) allowing the buyer to select, for inquiry, at least one selected seller from the list of a plurality of sellers;

(v) sending, from the computer server, an inquiry e-mail to the at least one selected seller using the anonymized e-mail address as sender address, wherein the inquiry e-mail includes instructions for optionally retrieving the request via the Internet.

An anonymized e-mail address could be something like post-93@questbid.com which is mapped to a real address such as mary@yahoo.com. The marketplace sends out an inquiry e-mail to matched sellers selected by the buyer, with the anonymized e-mail address as the sender.

For example, in some non-limiting embodiments, the recipient (the seller) can simply reply to the e-mail. The marketplace will receive the reply as it is within its controlled or rented domains (e.g., questbid.com or any other domain owned or accessible). The marketplace then relays the reply to the real buyer e-mail address. Alternatively, the marketplace can employ a private message functionality within the web site and send a notification to the user to retrieve the reply. The buyer can ultimately select at least one seller to initiate a transaction for a product or service.

In other embodiments, for illustration purposes only, the inquiry e-mail also contains a link to the forum post. The seller can click the link to go to the forum and post an anonymous offer to the forum message. The seller can click the request poster link to send a message. The marketplace then relays the reply to the real buyer e-mail address. Again, the marketplace can optionally employ a private message functionality within the web site and send a notification to the user to retrieve the reply. The buyer can ultimately select at least one seller to initiate a transaction for a product or service.

This method employing e-mail anonymization can be very beneficial from the standpoint of protecting identities. The marketplace sends an inquiry e-mail with the anonymized buyer address. Upon receipt of the inquiry e-mail, the anonymized buyer address but not the buyer's real e-mail address is known to the seller. The buyer's identity is protected. Both parties do not know each other's true identity even though they can negotiate directly, similar to a voice conference call.

In some embodiments that include e-mail anonymization, an Internet-based discussion thread suitable for participation by multiple persons is provided, wherein a seller can place a bid even if the seller is not contained on the list of a plurality of sellers from step (iii). The selected seller can optionally post, on (or to) the discussion thread, an anonymous offer to the buyer.

Some embodiments further comprise receiving a seller reply e-mail from the selected seller via the anonymized e-mail address, and then relaying the seller reply e-mail to the buyer e-mail address. Some embodiments further comprise sending a notification to the buyer to retrieve the seller reply e-mail via the Internet, preferably at a web site associated with the marketplace linked to, and under at least partial control of, the network-connected computer server.

Certain embodiments of the invention are premised on the utilization of “match agents” that can conduct seller searches over a period of time automatically. For example, a time-based task scheduler can be implemented for searching sellers to match the buyer's service request and then automatically sending inquiries on behalf of the buyer to some or all of the matched providers from each task. The buyer can optionally review search results (alerts) and manage inquiries deriving from each specific task. In some embodiments, buyers need to explicitly approve prior to inquiries being sent. In other embodiments, inquiries are sent automatically without confirmation by buyers, who can be subscribed to such service with the ability to opt-out.

This invention includes e-commerce systems comprising a server computer configured to exchange data with a network, said server computer having a processor, an area of main memory for executing program code under the direction of said processor, a storage device for storing data and program code and a bus connecting said processor, main memory and said storage device; the code being stored in said storage device and executing in said main memory under the direction of said processor, to perform the steps of any one of the methods described herein.

### Example 1

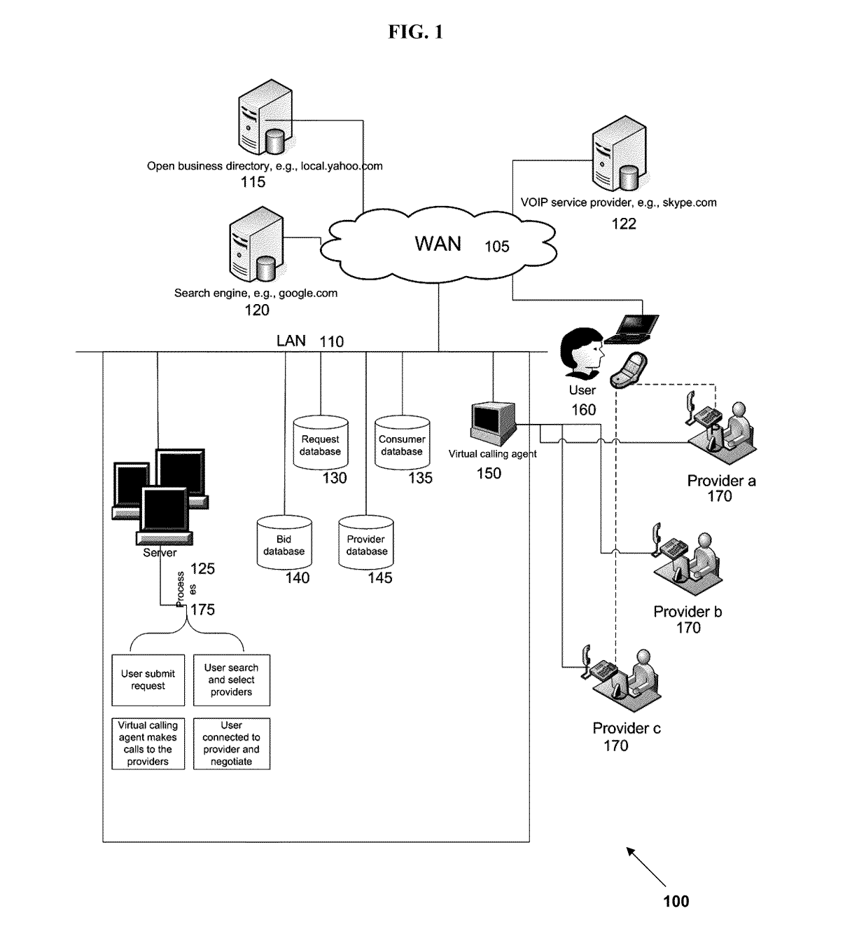

Reference can be made to FIG. 1, which illustrates some embodiments of a system 100 of the invention that can be utilized by a user 160 and providers 170. A wide area network (WAN) 105 is connected to a local area network (LAN) 110. The WAN 105 is connected to an open-listed business directory 115, such as local.yahoo.com; a search engine 120, such as google.com; and a Voice over Internet Protocol (VOIP) service provider 122, such as skype.com. A server 125 is provided and connected to the LAN 110, and is capable of carrying out processes 175 comprising receiving a user request; user selecting providers; virtual agent making at least one call to a provider; and a user being connected to at least one provider for possible negotiations. The LAN 110 is further connected to a request database 130, a consumer database 135, a bid database 140, and a provider database 145. The virtual agent 150 can make calls to one or more providers 170 (illustrated as three providers in FIG. 1 as an example only) on behalf of the user 160.

### Example 2

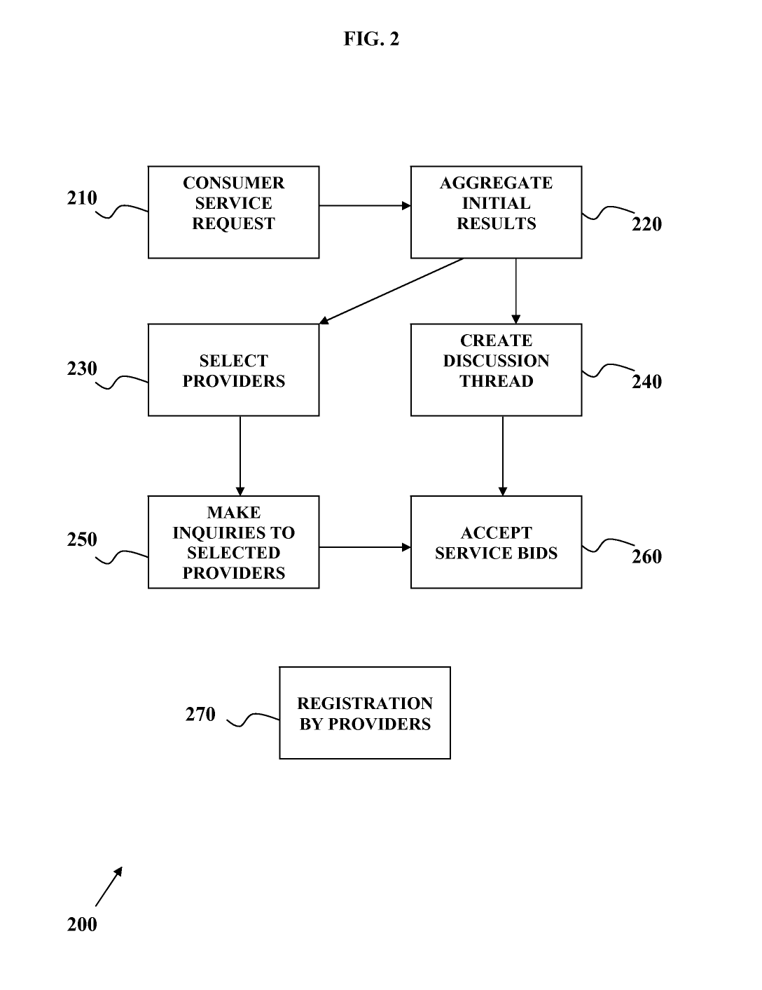

Reference can be made to FIG. 2, which illustrates some embodiments of a method 200 of the invention. A consumer service request 210 is received. First, initial results are aggregated 220. From these results 220, providers are selected 230 and a discussion threaded can be created 240. After providers are selected 230 according to the techniques described herein above, inquiries can be made to selected providers 250 which may include pre-registered providers. From these inquiries, one or more bids may be accepted 260 into the system. Providers can bid for the service, ask for clarification, and make an offer if desired. Also, providers can ask to be connected directly to the consumer for further discussion. The discussion thread can also lead to one or more service bids being accepted 260. From these accepted bids, one may prove to be an acceptable offer for the consumer. Optionally, one or more providers can register 270.

### Example 3

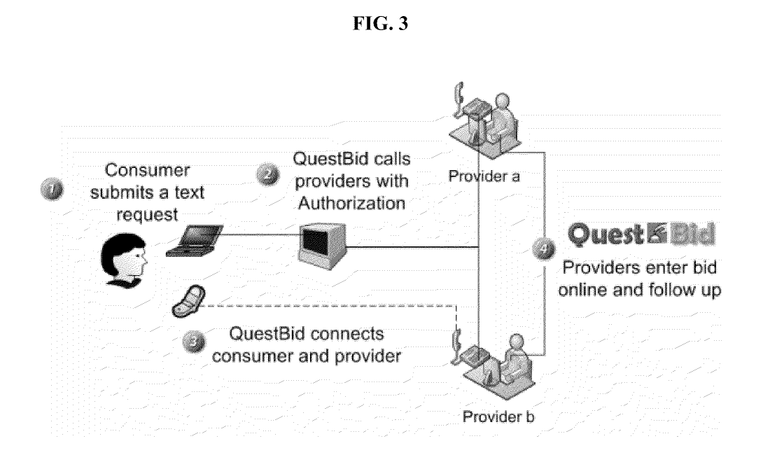

Reference can be made to FIG. 3, which illustrates a variation of the invention relating to the QuestBid marketplace. QuestBid provides a collection of online resources, including anonymous consumer requests, forum, calls to service providers authorized by consumers and various e-mail services.

Consumers can create a request without needing to provide a name, phone number, or address. Consumers can then select providers for inquiries to be made by QuestBid. QuestBid initiates a conference call to connect the consumer and the provider. Provider bids can be reviewed in a discussion thread. Bids are transparent to encourage competition, so that the consumer can get the best deal.

Providers receive an inquiry from QuestBid. The provider can listen to the consumer's request for a product or service. The provider can speak to the consumer right away if desired. Incoming inquiries can be reviewed and, if desired, bidded. Additionally, a provider may sign up at QuestBid by entering a business phone number.

Although illustrative embodiments and examples, and various modifications thereof, have been described in detail herein, one skilled in the art will appreciate that the present application need not be limited to these precise embodiments and the described modifications, and that various changes and further modifications may be practiced without departing from the scope or spirit of the invention as defined in the appended claims. Other embodiments will be apparent to those of ordinary skill in the art, including embodiments that do not provide all of the features and advantages set forth herein. These other embodiments are also within the scope of this invention.

What is claimed is:

1. A method of finding at least one suitable provider of a service requested by a user, said method comprising:
(i) receiving, at a network-connected computer server, a service request submitted by a user;
(ii) generating, in said network-connected computer server, an initial list of a plurality of service providers, wherein at least one of said plurality of service providers is open-listed and each open listing is associated with a method of contact selected from the group consisting of telephone number, fax number, e-mail address, web address, instant message, and text message;
(iii) producing, in said network-connected computer server, a message, comprising said service request, from data supplied by said user;
(iv) providing an automated system capable of contacting said service providers, wherein said system is integrated with said network-connected computer server;
(v) contacting at least two of said plurality of service providers and communicating said message provided according to step (iii); and
(vi) allowing for at least one suitable service provider to contact said user.

2. The method of claim 1, wherein said message in step (iii) is a voice message, said system in step (iv) is an automated telephony system, and said communicating in step (v) comprises automated telephone calls.

3. The method of claim 1, comprising communication in step (i) and/or step (vi) by one or more means selected from the group consisting of Internet, telephone, Internet phone, facsimile, satellite phone, radio, e-mail, instant messaging, and cellular text messaging.

4. The method of claim 1, wherein said contacting is achieved by a conference call and wherein contact information of said user is not communicated to said providers.

5. A method of finding at least one suitable provider of a service requested by a user, said method comprising:
(i) receiving, at a network-connected computer server, a service request submitted by a user;
(ii) generating, in said network-connected computer server, an initial list of a plurality of service providers, wherein at least one of said plurality of service providers is open-listed and each open listing is associated with a method of contact selected from the group consisting of telephone number, fax number, e-mail address, web address, instant message, and text message;
(iii) contacting separately at least two of said plurality of service providers and communicating said service request; and
(iv) allowing for at least one suitable service provider to contact said user.

6. The method of claim 5, comprising an assisted conference call including a customer representative, said user, and said service provider, wherein said customer representative assists said service provider prior to connection with said user.

7. The method of claim 6, further comprising real-time streaming of a phone conversation that includes said service provider, to said user prior to said conference call.

8. The method of claim 7, wherein a server directly streams an audio device connected to a computer.

9. The method of claim 7, wherein said phone conversation is recorded to a file that is continuously written during said phone conversation, and wherein said file is converted into an audio signal for transmission over a network to said user.

10. The method of claim 7, comprising a virtual audio device technique whereby a plurality of virtual audio devices, on a single physical machine, are capable of conducting multiple phone calls simultaneously.

11. The method of claim 5, wherein step (iv) includes live instructions or a voice message to said service provider that includes information for retrieving said service request, and optionally following up, via the Internet.

12. The method of claim 11, wherein said retrieving can be accomplished by said provider typing in a business phone number or identification number associated with said provider.

13. The method of claim 5, further comprising the step of (v) generating an Internet-based discussion thread suitable for participation by multiple persons, wherein a provider can place a bid even if said provider is not contained on said initial list of a plurality of service providers.

14. The method of claim 5, wherein an e-mail containing said service request is transmitted to said service provider, wherein said e-mail includes an identifying Internet link for connecting to data comprising said service request.

15. A method of anonymously matching one or more buyers with one or more sellers for a product or service, said method comprising:
(i) receiving, at a network-connected computer server, a request submitted by a buyer having a buyer e-mail address that is recorded on said computer server;
(ii) converting said buyer e-mail address to an anonymized e-mail address that is mapped to said buyer e-mail address, wherein said converting is computationally carried out within said computer server;
(iii) generating, in said network-connected computer server, a list of a plurality of sellers, wherein at least one of said sellers is open-listed;
(iv) allowing said buyer to select, for inquiry, at least one selected seller from said list of a plurality of sellers;
(v) sending, from said computer server, an inquiry e-mail to said at least one selected seller using said anonymized e-mail address as sender address, wherein said inquiry e-mail includes instructions for optionally retrieving said request via the Internet.

16. The method of claim 15, comprising providing an Internet-based discussion thread suitable for participation by multiple persons, wherein a seller can place a bid even if said seller is not contained on said list of a plurality of sellers from step (iii).

17. The method of claim 16, further comprising allowing said selected seller to post, on said discussion thread, an anonymous offer to said buyer.

18. The method of claim 15, further comprising receiving a seller reply e-mail from said selected seller via said anonymized e-mail address, and then relaying said seller reply e-mail to said buyer e-mail address.

19. The method of claim 18, further comprising sending a notification to said buyer to retrieve said seller reply e-mail via the Internet.

20. The method of claim 15, additionally comprising implementing an automatic task scheduler for conducting searching of said sellers to match said buyer's service request and sending inquiries to some or all of said sellers from each task.
